(19) United States
(12) Patent Application Publication
(10) Pub. No.: US 2001/0018747 A1
(43) Pub. Date: Aug. 30, 2001

(54) Method and system for an access manager granting privileges within a communications network

(76) Inventor: Nicolas Bouthors, Meylan (FR)

Correspondence Address: Jeffrey D. Shewchuk, THE KINNEY & LANGE BUILDING, 312 South Third Street, Minneapolis, MN, 55415-1002, US

(21) Appl. No.: 09/792,315

(22) Filed: Feb. 23, 2001

(30) Foreign Application Priority Data
Feb. 29, 2000 (FR) 00 02575
Nov. 22, 2000 (FR) 00 15103

(51) Int. Cl. H04L 9/00; H04L 9/32; G06F 11/30; G06F 12/14

(52) U.S. Cl. 713/201

(57) ABSTRACT

This invention relates to a method for an access manager granting privileges within a communications network (3) to at least some of his customers. The communications network interconnects a plurality of sites (A, B), which a customer can access selectively via a terminal (1, 2), by activating a corresponding access link. According to the invention, a list of privileged access links (URL1) is managed, each corresponding to a site (A) and/or a service of a site, a partnership agreement having been signed between the access manager and a manager of the site for the privileged access links. When an access link activated and/or received by one of the customers is one of the privileged access links (URL1), it is replaced with a substitution access link (URL′), so that the customer gains access, via an intermediate equipment (8) of the communications network corresponding to the substitution access link, to a destination belonging to the group comprising: site (A) and/or the service corresponding to the activated and/or received privileged access link (URL1), and site (B) and/or service, different from the one corresponding to the activated and/or received privileged access link (URL1).

The field of the invention is that of access management within a communications network interconnecting a plurality of sites. It is assumed in the course of the description that the customer can selectively access each of the sites, via a terminal, by activating an access link corresponding to the site he has chosen.

More precisely, the invention relates to a method and system for granting privileges, associated with such access links, to customers.

In particular, but not exclusively, the communications network can be a network of internet type, like the Internet worldwide web. In this case, access links are destination addresses (or URL addresses, “Uniform Resource Locator”) to information pages (or web pages).

Furthermore, this invention is applied not only when the customer directly accesses the communications network, but also when he gains access thereto via (at least) one other telecommunications network to which he has subscribed. This other telecommunications network is for instance the public switched telephone network (“fixed network”) or a radio communications network (“mobile network”).

In the case of a radio communications network, e.g. the GSM (“Global System for Mobile communications”) standard is used, or an equivalent or competing standard, such as DCS 1800 (“Digital Cellular System at 1800 MHz”), PCS 1900 (“Personal Communication System at 1900 MHz”), DECT (“Digital European Cordless Telecommunications”), GPRS (“General Packet Radio Service”), or UMTS (“Universal Mobile Telecommunication System”).

In order to explain the disadvantages of prior art in terms of access management, the current technique of managing web page access, within the Internet network, will now be recalled. Conventionally, a web page can be associated either with a site (home page), or part of a site (other page(s) of the site). Each web page may also correspond to a service of a site.

Obviously, the disadvantages that will be described by means of this illustrative example are common to other prior art access management techniques.

It is assumed that the customer has subscribed to a telecommunications network interconnected with the Internet network. Via his terminal (or “network equipment”), he sends a request to connect to the Internet network via his provider who then takes care of providing a communication between the customer's terminal and the Internet network. When this communication has been established, the customer can access various web pages, according to a client/server mode. For this purpose, there is some client software included in his terminal, i.e. a browser, having in particular a direct operating mode and an indirect operating mode.

In direct operating mode, the browser uses URL addresses the user knows and directly passes on to the browser.

In indirect operating mode, the browser uses hypertext links (or hyperlinks) contained in another web page, displayed on the terminal screen. Each hyperlink comprises, on the one hand, a URL address and a hypertext link area (image and/or text) contained in the web page displayed on the terminal screen.

Once the customer has provided a URL address, directly by input (direct mode) or indirectly by clicking on a hypertext link area corresponding to a web page he has chosen (indirect mode), the browser sends a query containing the corresponding URL address. In both instances, this is called activation of the access link, which is the URL address.

This query is received by the server containing the web page searched for (i.e. the URL address of which has been provided), so that in return, this web page is dispatched by the server on the network, in a special language, HTML (“Hypertext MarkUp Language”). This language contains commands (tags) informing the customer terminal browser of how to lay out the web page upon receipt.

The conventional use of URL addresses, as described above, has several disadvantages and does not allow to meet all requirements.

First of all, it does not promote the development of sales promotion on the Internet. Indeed, since no alternative is available, sales promotion is nowadays focussing on advertising bands (or banners), which are hypertext link areas added to certain web pages, and whereon internet surfers can click to be directed towards other web pages. A disadvantage of such bands is that they only let through a limited flow of sales data, so as not to increase the downloading time of the web pages supporting them.

Moreover, it often happens that the customer is not enthusiastic, or even reluctant, to look up certain web pages, and in particular purely advertising pages, considering that he is generally paying for his internet connect time. Indeed, at present, when he wishes to access the Internet network, the customer must take out a subscription, with an access provider, for which he generally has to pay (fixed rate, time dependent rate, or else depending on the cost standard of local calls). It should be noted that sometimes also free subscriptions are proposed, but in this case, it is the access provider who bears the access cost. Consequently, even in this case, the issue of bearing connection cost remains.

A mechanism should therefore be imagined that allows to invoice the cost of accessing certain web pages, partially or totally, neither to the customer nor to the access provider. E.g., the owner of a web site may wish his site to be accessible for free, both for the customer and for the access provider.

The above on providing advertising or sales information also applies of course, more generally, to providing any kind of information.

Furthermore, the conventional use of URL addresses does not allow to automatically filter customers effectively having access, partially or totally, to certain sites (home pages) and/or certain specific services (other web pages).

It is yet another disadvantage that it does not allow to distinguish between several different circuits accessing a given URL address.

In particular, it is the object of the invention to compensate for the various disadvantages of the state of the art.

More precisely, one of the objects of this invention is to provide an access management technique within a communications network, enabling an access manager to grant privileges to his customers.

In particular, but not exclusively, privileges mean a modification of the costs for accessing a site and/or a service of a site, the possibility of accessing a site and/or part of a restricted site and/or a specific service of a site, the possibility of accessing a site and/or a service of a site via a specific circuit, . . . .

It is also an object of the invention to provide such a technique that is easy and cost effective to implement.

It is another object of the invention to provide such a technique, one alternative embodiment of which requires no modification of customer terminals.

It is yet another object of the invention to provide such a technique, one alternative embodiment of which requires no modification of the site managers' hardware.

These various objects, as well as others that will be apparent hereafter, are achieved according to the invention by means of a method for an access manager granting privileges within a communications network to at least some of his customers, said communications network interconnecting a plurality of sites a customer can access selectively via a terminal, by activating a corresponding access link. According to this invention, a list of privileged access links is managed, each corresponding to a site and/or a service of a site, a partnership agreement having been signed between said access manager and a manager of said site for said privileged access links. When an access link that has been activated and/or received by one of said customers is one of said privileged access links, it is replaced with a substitution access link, so that said customer gains access, via an intermediate equipment of said communications network corresponding to said substitution access link, to a destination belonging to the group comprising: said site and/or said service corresponding to said activated and/or received privileged access link, and another site and/or service, different from the one corresponding to said activated and/or said received privileged access link.

This invention is therefore based on the general concept of replacing a “privileged access link” with a “substitution access link”, so that the customer accesses a given destination (that can be different from the one initially requested) via an intermediate equipment. In general, this replacement is done upstream of the intermediate equipment (different alternative embodiments of this replacement are proposed and discussed in detail below).

It will be noted that in order to redirect the customer to his final destination, the intermediate equipment must previously locate the “privileged access link” for which the “substitution access link” was substituted.

Advantageously, said access manager within the communications network belongs to the group comprising: access providers, providing an interconnection between said communications network and a telecommunications network, and service providers who are not access providers.

A service provider who is not an access provider is in particular, but not exclusively, a company managing an intermediate equipment as mentioned above, and therefore capable of granting privileges to his customers without for all that being an access provider.

Advantageously, the replacement of one of said privileged access links and/or the activation of one of said substitution access links requires the authorization of said customer and/or said site manager and/or said access manager.

In other words, various access control functions, managed by different entities of the system, can be provided, individually or in combination.

In order to obtain the authorization of the site manager, the access manager can deviate an authorization query thereto, via the implementation of a secure protocol.

Preferably, said authorization of the site manager and/or said access manager depends on whether said customer belongs to a group of predetermined customers.

In particular, but not exclusively, a group of customers is a group of subscribers of the site manager, the access manager, . . . , or else a group of customers of the same geographical area.

Preferably, if no authorization of said customer and/or said site manager is available, it is proposed to said customer to access said site and/or said service corresponding to the activated and/or received privileged access link without privileges.

In an advantageous embodiment of the invention, said privileged access links and/or said substitution access links can be identified directly, on the terminal of one of said customers.

Thus, the customer is encouraged to use the sites and/or services which he can access with privileges.

Preferably, said identification of one of said privileged access links and/or one of said substitution access links consists in said terminal modifying the graphical and/or sound representation of said privileged access link and/or said substitution access link.

Preferably, the replacement of one of said privileged access links by one of said substitution access links is made according to one of the techniques belonging to the group comprising:

prior static replacement, by said site manager;

dynamic replacement, by an equipment of said communications network and/or an equipment of said customer.

It will be noted that the dynamic replacement takes place transparently for the site manager. It will also be noted that neither the static replacement nor the first two alternatives of dynamic replacement require a modification of customer terminals.

Advantageously, in order to locate the privileged access link for which said substitution link has been substituted, said intermediate equipment implements a technique belonging to the group comprising:

disencapsulating said privileged access link contained in said substitution access link;

looking up a matching table associating with each substitution access link the privileged access link replaced therewith.

The first alternative (disencapsulation) of course assumes prior encapsulation of the privileged access link in the substitution access link during the so-called replacement step.

Advantageously, the privileges associated with each of said substitution access links belong to the group comprising:

modifying the costs for accessing a site and/or a service of a site;

accessing a site and/or part of a restricted site;

accessing a specific service of a site;

accessing a site and/or a service of a site via a specific circuit.

Access costs are, e.g., the primary costs for gaining access to the communications network (via one or several intermediate networks, fixed (RTC) or mobile (GSM, . . . )), and/or the secondary cost for entering the communications network as such. Thus, for the Internet, the primary costs are zero whereas the secondary costs, which are not zero, are generally charged to the customer (payable service of the access provider).

In a specific embodiment of the invention, said communications network is an internet-like network, and said access links are destination addresses of information pages.

Therefore, in the particular case of the Internet, the invention is applied both to the direct operating mode and the indirect operating mode. It is recalled that whatever the operating mode, activating an access link consists in sending via the browser a query containing the requested URL address.

In a first advantageous alternative embodiment of the invention, the method comprises a step of limiting the activations, performed by all of said customers, of at least one given substitution access link.

Thereby, the site (and/or service) manager who is accessed as a result of said given substitution access link being activated can limit the privileges he wishes to associate with this given substitution access link. E.g., if the privilege consists in at least partially bearing the cost for accessing the site (and/or service), the site manager can thus decide on a budget not to be exceeded as part of this agreement to bear the cost.

In a second advantageous alternative embodiment of the invention, the method comprises a step of limiting the activations, performed by a group of at least one given customer, of said substitution access links.

Unlike the first alternative embodiment, here it is not the number of activations of a single given substitution link, by all customers, that is interesting, but the number of activations of all substitution access links, by one or several given customers.

This enables the access manager to check that a maximum viewing number per customer is complied with. This functionality is particularly interesting for continuous (audio and/or video) viewing (streaming), if the facilities know how to control broadcasting thereof. E.g., the number of sessions viewed by each customer is controlled.

In a specific embodiment, the activation of one of said substitution access links by a given user is followed, after a given time, by a step of said given user confirming the use of the site and/or service access of which is the result of said activation. If no confirmation by said given user is available, said use is interrupted.

Advantageously, at each activation of one of said substitution access links, the access manager provides the site manager with:

a query from one of said customers, with said substitution access link;

at least one additional piece of information, regarding said access manager and/or the access mode of said customer and/or to said customer.

The invention also relates to a system for an access manager granting privileges within a communications network to at least some of his customers, said communications network interconnecting a plurality of sites a customer can selectively access via a terminal, by activating a corresponding access link. According to the invention, this system comprises:

means for managing a list of privileged access links each corresponding to a site and/or a service of a site, a partnership agreement having been signed between said access manager and a manager of said site for said privileged access links;

means for replacing an access link activated and/or received by one of said customers, if this is one of said privileged access links, with a substitution access link.

Thereby, said customer gains access, via an intermediate equipment of said communications network corresponding to said substitution access link, to a destination belonging to the group comprising:

said site and/or said service corresponding to said activated and/or received privileged access link;

another site and/or service, different from the one corresponding to said activated and/or received privileged access link.

Other features and advantages of the invention will be apparent from reading the following description of a preferred embodiment of the invention, given by way of an illustrative example and not to be restrictive, and the appended drawings, where:

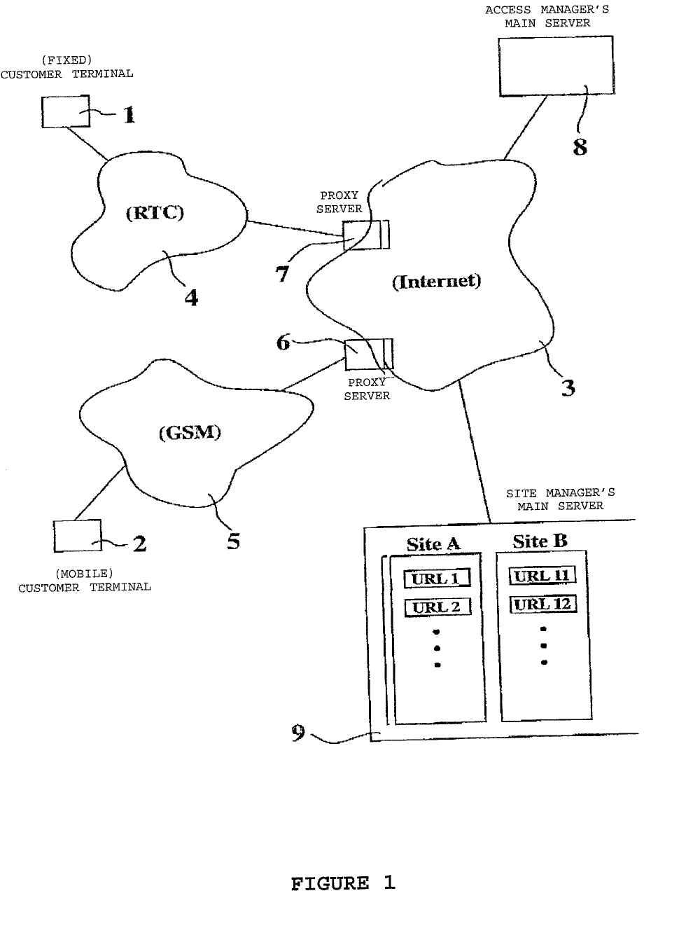

FIG. 1 is a diagram of a sample configuration of communications networks wherein the invention can be implemented;

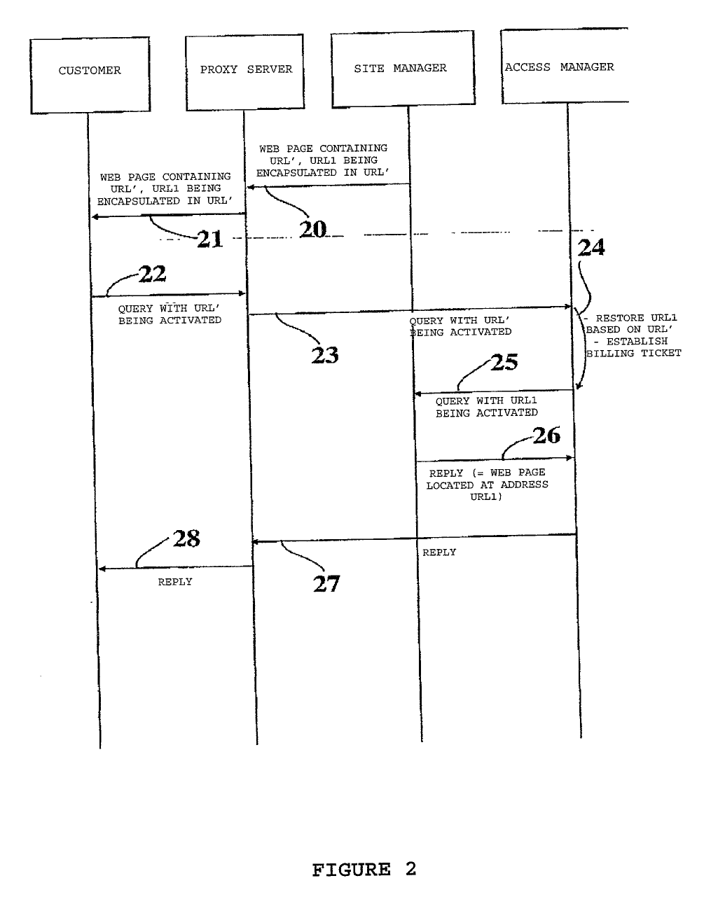

FIG. 2 schematically illustrates the successive steps of a first embodiment of the method for granting privileges according to the invention; and

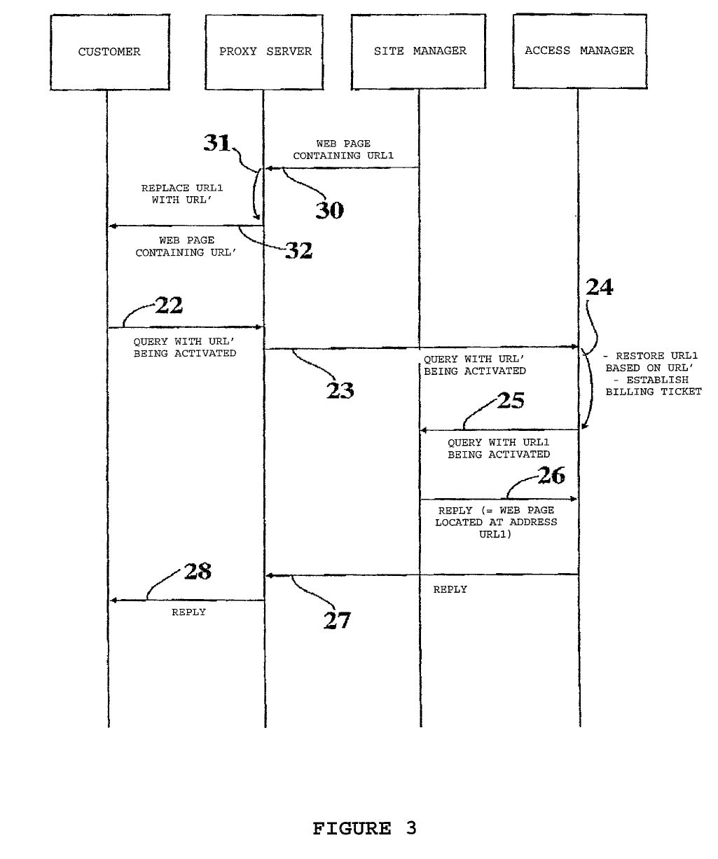

FIG. 3 schematically illustrates the successive steps of a second embodiment of the method for granting privileges according to the invention.

In the configuration of FIG. 1, customers have subscribed either to the switched telephone network (RTC) 4 or a radio communications network (e.g., according to the GSM standard, or the like) 5, and respectively use either a fixed terminal 1 or a mobile terminal 2. They can access web sites of the Internet network 3, via a gateway (or proxy server) 6, 7 interconnecting the network 4, 5 to which customers have subscribed and the Internet network 3.

Proxy servers (or relay servers) are managed by an Internet access provider, who is for instance also the operator of network 4, 5 to which the customer has subscribed.

In general, there are:

“cache” proxy servers allowing to store the web pages which are subject to the most frequent queries, in order to avoid queries on remote servers. In this case, the queries managed by the proxy servers are thus not always handed down to the final site;

“pass” proxy servers allowing to dynamically modify a query (replacing one server name with another) in order to enable load sharing among servers.

As part of the embodiment described, it should be noted that it is critical for the operator to control the first “cache” proxy server encountered by the user when he accesses the Internet network, which can happen if the operator is the access operator.

The access links that the customers activate to access the various sites available are URL addresses. It is recalled that a URL address is a destination address of a web page. It comprises:

the type of service (e.g., “http://”for a web server);

the FDQN (“Full Qualified Domain Name”) address of the server which is an IP-address translated into words according to the following rule: “www.organization.domain”;

the location of the web page searched for on the server (directory tree);

the name of the web page searched for;

possibly, additional parameters provided by the customer to specify the context of his request.

E.g., the URL address “http://www.sfr.com/abonnés/2000.htm” allows to initiate a query to the web server having the FDQN address “www.sfr.com”, in order to ask it to look for the web page “2000.htm” in the “abonnés” (subscribers) directory.

In the specific embodiment revealed herein, the invention relates to an access provider granting privileges to some of his customers within the Internet network 3.

The access manager is e.g. also the Internet access provider (who is in turn for instance also the operator of network 4, 5 to which the customer has subscribed). In this case, he has a main server 8 and the proxy servers 6, 7 mentioned before.

The access manager's main server 8, and possibly the proxy servers 6, 7, make(s) it possible to manage a list of privileged access URL addresses (or links), each corresponding to a specific web page. It is assumed that a partnership agreement has been signed between the access manager and the manager(s) of the site(s) the web pages of which have these privileged access URL addresses. The site manager is sometimes also called information and/or service provider.

Obviously, in the list of privileged access URL addresses, URL addresses can be found that correspond to several web pages of the same site. This list contains for instance all the pages of a site (the URL addresses of which contain the same FDQN address), or else all the pages of a given directory or sub-directory of a site (the URL addresses of which contain the same FDQN addresses and one or several identical directory tree levels.

For the sake of simplification, and as illustrated in FIG. 1, it is assumed in the course of the description that the list of privileged access URL addresses comprises only the URL addresses (URL1, URL2, . . . ) corresponding to the web pages of a site A, located on the main server 9 of a single site manager. It should be noted that this server 9 also supports another site B, revealed in detail hereafter, the web pages of which have URL addresses URL11, URL12, . . . .

When a customer activates (in a query) or receives (in a web page) one of the privileged access URL addresses, the general principle of the invention consists in replacing it with a substitution URL address containing the address of the access manager's main server 8. Thus, it is eventually a query for the address of the access manager's main server 8 that is transmitted by the customer. Based on this first query, the access manager's main server 8 locates the privileged access URL address and builds a second query either for this URL address or for another predetermined one. When it receives the answer to this second query, it is sent back to the customer for whom the operation is transparent.

E.g., the customer having the mobile terminal 2 activates the address URL1 of site A of the site manager. In proxy server 6, the address is replaced with an address URL′ containing the address “www.sfr.com” of the access manager's main server 8. The latter builds a query either for the address URL1 of site A or for the address URL11 of site B.

This mechanism of passing through the access manager's main server 8 enables the latter to grant privileges to at least some of his customers.

In particular, it enables the access manager to distinguish sales flows (advertising web pages) so that they can be billed (i.e., access thereto is billed) not totally to the customer but at least partially to the manager(s) of the site(s) containing these advertising web pages. It is even possible to provide for the access manager also to bear part of the access cost. One of the applications of this invention is thus a novel approach to sales promotion on the Internet.

In the course of the description, only the case of a privilege consisting in a (partial or total) reduction for the customer of the access cost related to accessing one or several specific web pages mentioned before is considered. However, the invention obviously also applies to other privileges, such as in particular accessing a restricted site and/or at least one web page of a restricted site.

The mechanism of passing through the access manager's main server 8 also enables the manager to provide an access control function. Indeed, the actual replacement of a privileged access URL address with a substitution access URL address can be associated with previously obtaining an authorization from the site manager and/or the access manager and/or the customer. Alternatively (or in combination), it can be provided that the activation of a substitution access URL address also requires previously obtaining an authorization.

If the authorization is requested from the customer, the latter can be informed, prior to making his decision, of the type of privilege offered.

E.g., the site manager may accept to bear the connecting costs for certain web pages of his site only for customers located in a given geographical area (case of a sales campaign limited to a town), or belonging to a given group (case of customers having a subscription with this site manager or access manager).

If no authorization is available, the customer can be offered to access the requested web page all the same, but in this case without any privilege. E.g., the customer accepts to pay the costs for accessing a business web page.

With reference to FIG. 2, we are now going to reveal a specific embodiment of the method for granting privileges according to the invention.

Here, it is assumed that the site manager wishes to bear all of the costs for accessing the web page (of his site A) located at the address URL1. For this purpose, he replaces, in a prior static way (“encapsulation”), this privileged access address URL1 with a substitution access address URL′. The address URL′ is the one discussed above with reference to FIG. 1, and therefore contains the address “www.sfr.com” of the access manager's main server 8. E.g., it looks like this:

“http://www.sfr.com/free/encaps=ZZZ,mode=free, cond=100%”

where ZZZ represents a codification of the address URL1 so that it can be restored by the access manager's main server 8.

We are now going to describe the successive steps schematically illustrated in FIG. 2.

Steps 20 and 21: the customer receives from the site manager, via the proxy server, a web page including at least one hyperlink to another web page. This hyperlink comprises the above-mentioned address URL′ and an associated hypertext link area (to appear within the web page when it is displayed on the screen of the customer's terminal).

It should be noted that in order to inform the customer of the specific type of the address URL′, this address and/or its associated hypertext link area can be modified as to their graphical (e.g., presence of a specific character string, such as “800”) and/or sound representation.

Steps 22 and 23: the customer sends a query with the activated address URL′. This query is transmitted via the proxy server to the access manager's main server.

Step 24: upon receipt of this query, the access manager's main server restores the address URL1 (through disencapsulation or use of a matching table) and establishes a billing ticket (or CDR, “Call Detailed Record”). This billing ticket can contain data regarding time, access method, volume transferred, transfer duration, the required address URL1, . . . . It can be used as a basis for a new key for distributing the costs among the customer, the site manager, the access manager, or any other entity involved in the privilege granting system.

The access manager's main server can also request the authorization of the customer for the conditions (partially or totally free) offered. For this purpose, several techniques are possible. First of all, to use the acknowledgement associated with the query for indicating conditions, as well as additional information (“This is a video, lasting . . . , transmission will be deducted from your call. Do you wish to accept? Yes/No”). It should be noted that this part of the call can be performed via secure and/or signed links or not.

Steps 25 and 26: the access manager's main server sends a query with the activated address URL1. This query is transmitted to the main server of the site manager which replies by sending the web page located at address URL1.

Steps 27 and 28: the access manager's main server gets this reply to the customer, via the proxy server.

Obviously, if the customer knows the address URL′ (it can be published in a log), he can input it directly on his terminal, and the method then directly starts at step 22.

With reference to FIG. 3, we are now going to reveal a second specific embodiment of the method for granting privileges according to the invention.

This second embodiment differs from the first one described above only as for the technique used for performing the replacement of the privileged access address URL1 with the substitution access address URL′. Only the first three steps 30 to 32 of this second embodiment are involved and thus described below. The steps remaining unchanged for both embodiments have the same reference numerals 22 to 28.

Again, it is assumed that the site manager wishes to bear the total cost for accessing the web page (of his site A) located at the address URL1.

Moreover, it is recalled that the proxy is part of the equipment of the access manager, who, in the example discussed, is the same as the Internet access provider.

Step 30: the site manager sends the customer, via the proxy server, a web page including at least one hyperlink to the web page located at the address URL1. This hyperlink thus comprises the address URL1 and the associated hypertext link area.

Step 31: the proxy server analyzes all replies (i.e., the web pages) it relays, and searches them for the presence of one or several privileged access URL addresses (i.e., in this case, a number of character strings). For this purpose, the proxy server can read out the tags <A href=xyz> Text </a> in the html replies. When it detects one of the privileged access URL addresses (URL1 in this example), it dynamically performs the replacement thereof, within the web page, with a substitution access URL address (URL′ in this example).

Such a dynamic replacement can be done in a “pass” type proxy server. It is important to note that, in this case, a functionality that already exists but is not designed for this purpose is used in a novel and not obvious fashion. Indeed, the point here is not to allow load sharing among servers.

Step 32: the proxy server gets the web page thus modified (i.e., containing the address URL′) to the customer.

It should be noted that with this second embodiment, the site manager does not have to modify the privileged access URL addresses contained in his web pages.

In general, the replacement can be performed by any Internet network equipment (proxy server, router, . . . ), or else by the customer's terminal. In the case of a router, it is e.g. equipped with some specialized software capable of performing the above mentioned Internet frame “spying” operation, on the HTTP packets of replies to “GET” or “POST” type queries.

In order to reduce the extend of the search preceding the replacement, it can be decided to restrict this search to privileged access URL addresses including a specific character string. It can be envisaged to include this string in any of the fields composing a URL address. Thus, with the string “800” and starting with a URL address of the type “http://www.aa.AA/BB/c=CCC,d=DDD”, the following possibilities can be envisaged (this list is not comprehensive):

http://www.aa.AA/BB/c=CCC,d=800

http800://www.aa.AA/BB/c=CCC,d=DDD

http://www.aa.AA/BB/800/c=CCC,d=800

http://www.aa.AA/800/BB/c=CCC,d=800

. . .

It should be noted that these URL addresses can be processed by the site manager's server to point to the original resource, merely by configuring this server.

Optionally, this invention also provides for a restriction of the activations of substitution access links. In a first alternative embodiment, activations, performed by all customers, of a given substitution access link is restricted. In a second alternative embodiment, activations, performed by a given customer (or a group of given customers) of all substitution access links is limited.

Whatever the alternative embodiment implemented, limiting activations consists in, e.g.:

maintaining at least one activation counter;

comparing the counter value with a predetermined threshold (maximum number of activations for a given period, maximum number of simultaneous activations, minimum number of activations for a given period, minimum number of simultaneous activations, . . . );

triggering at least one appropriate action before and/or after the counter value exceeds the predetermined threshold.

In particular, but not exclusively, appropriate action is triggering an alarm just before the counter reaches the predetermined threshold, triggering an alarm when the counter has reached the predetermined threshold, prohibiting any further activation after the counter has reached the predetermined threshold, etc.

Also optionally, activation of one of the substitution access links by a given user is followed, after a given time, by a step of the given user confirming the use of the site and/or service access of which is a result of the activation mentioned above. If confirmation by the given user is not available, use is interrupted.

E.g., in case of continuous contents (e.g., movie) viewing (streaming) by a customer, the access manager can thus make sure that the customer pays the transmission after having received part of the contents. The implementation of this functionality consists in, e.g., when a customer requests to read some contents, in launching an applet in the customer's browser. The applet requests confirmation of the customer's viewing order, and proposes an access link (URL address) to call in view of this confirmation. In case the customer rejects it, or does not reply, the server of the contents provider interrupts the continuous viewing (streaming) process.

According to yet another option of the invention, at each activation of one of the substitution access links, the access manager provides the site manager with:

a query from one of the customers, with the substitution access link;

one or several additional pieces of information relating to the access manager and/or the access mode of the customer and/or to the customer.

The additional information is used, e.g., by the site manager for calculating the costs of the privileges he is granting, or performing statistics on the dynamics of the use of these privileges, according to different access modes, different access managers, different customers, etc.

1. A method of an access manager granting privileges within a communications network (3) to at least some of his customers, said communications network interconnecting a plurality of sites (A, B) which a customer can access selectively via a terminal (1, 2) by activating a corresponding access link,
characterized in that a list of privileged access links (URL1) is managed, each corresponding to a site (A) and/or a service of a site, a partnership agreement having been signed between said access manager and a manager of said site for said privileged access links,
and in that, when an access link activated and/or received by one of said customers is one of said privileged access links (URL1), it is replaced with a substitution access link (URL′), so that said customer gains access, via an intermediate equipment (8) of said communications network corresponding to said substitution access link, to a destination belonging to the group comprising:
said site (A) and/or said service corresponding to said activated and/or received privileged access link (URL1);
another site (b) and/or service, different from the one corresponding to said activated and/or received privileged access link (URL1).

2. The method according to claim 1, characterized in that said access manager within the communications network belongs to the group comprising:
access providers, providing interconnection between said communications network (3) and a telecommunications network (4, 5);
service providers who are not access providers.

3. The method according to any of claims 1 or 2, characterized in that said privileged access links and/or said substitution access links can be directly identified, on the terminal (1, 2) of one of said customers.

4. The method according to claim 3, characterized in that said identification of one of said privileged access links and/or one of said substitution access links consists in said terminal modifying the graphical and/or sound representation of said privileged access link (URL1) and/or said substitution access link (URL′).

5. The method according to any of claims 1 to 4, characterized in that the replacement of one of said privileged access links with one of said substitution access links is performed according to one of the techniques belonging to the group comprising:
prior static replacement, by said site manager;
dynamic replacement, by an equipment of said communications network and/or an equipment of said customer.

6. The method according to any of claims 1 to 5, characterized in that, in order to locate the privileged access link for which said substitution link has been substituted, said intermediate equipment (8) implements a technique belonging to the group comprising:
disencapsulating said privileged access link contained in said substitution access link;
looking up a matching table associating with each substitution access link the privileged access link replaced therewith.

7. The method according to any of claims 1 to 6, characterized in that said communications network (3) is an internet-like network, and in that said access links are destination addresses (URL) of information pages.

8. The method according to any of claims 1 to 7, characterized in comprising a step of limiting activations, performed by all of the customers, of at least one given substitution access link.

9. The method according to any of claims 1 to 8, characterized in comprising a step of limiting activations, performed by a group of at least one given customer, of said substitution access links.

10. The method according to any of claims 8 and 9, characterized in that said activation limiting step comprises the following steps:
maintaining at least one counter related to said activations;
comparing the value of said counter with a predetermined threshold;
triggering at least one appropriate action before and/or after the counter value exceeds the predetermined threshold.

11. The method according to any of claims 1 to 10, characterized in that the activation of one of said substitution access links by a given user is followed, after a given time, by a step of said given user confirming the use of the site and/or the service access of which is a result of said activation,
and in that if no confirmation from said given user is available, said use is interrupted.

12. The method according to any of claims 1 to 11, characterized in that, at each activation of one of said substitution access links, the access manager provides the site manager with:
a query from one of said customers, with said substitution access link;
at least one additional piece of information, regarding said access manager and/or the access mode of said customer and/or to said customer.

13. A system for an access manager granting privileges within a communications network (3) to at least some of his customers, said communications network interconnecting a plurality of sites (A, B) which a customer can access selectively via a terminal (1, 2), by activating a corresponding access link,
characterized in comprising:
means for managing a list of privileged access links (URL1), each corresponding to a site (A) and/or a service of a site, a partnership agreement having been signed between said access manager and a manager of said site for said privileged access links;
means for replacing an access link activated and/or received by one of said customers, if this is one of said privileged access links, with a substitution access link (URL′),
so that said customer gains access, via an intermediate equipment (8) of said communications network corresponding to said substitution access link, to a destination belonging to the group comprising:
said site (A) and/or said service corresponding to said activated and/or received privileged access link (URL1);
another site (B) and/or service, different from the one corresponding to said activated and/or received privileged access link (URL1).
